(19) United States
(12) Patent Application Publication
(10) Pub. No.: US 2026/0297262 A1
(43) Pub. Date: Oct. 1, 2026

(54) METHOD FOR PRODUCING MALEIMIDE RESIN

(71) Applicant: Resonac Corporation, Tokyo (JP)

(72) Inventors: Tetsuya IMAI, Tokyo (JP); Kitaru SATO, Tokyo (JP); Yusuke BABA, Tokyo (JP)

(21) Appl. No.: 19/479,450

(22) PCT Filed: Nov. 1, 2024
(86) PCT No.: PCT/JP2024/039119

§ 371 Date: Oct. 28, 2025

(30) Foreign Application Priority Data
Nov. 6, 2023 (JP) 2023-189498

(51) Int. Cl. C08G 73/12

(52) U.S. Cl. CPC C08G 73/122

(57) ABSTRACT

A method for producing a maleimide resin by reacting a tetracarboxylic dianhydride (a1), an amine (a2), and a maleic anhydride (a3), the method including the steps of: adding the amine (a2) to the tetracarboxylic dianhydride (a1) in the presence of an organic solvent to obtain a polyimide resin; and adding the maleic anhydride (a3) to the polyimide resin to obtain the maleimide resin; in which the organic solvent includes at least one of γ-butyrolactone and N-ethyl-2-pyrrolidone, and the amine (a2) includes a dimer diamine and a second amine other than the dimer diamine.

### TECHNICAL FIELD

The present disclosure relates to a method for producing a maleimide resin.

### BACKGROUND ART

Printed wiring boards and multilayer wiring boards including the printed wiring boards are used in products such as mobile communication devices (for example, mobile phones and smartphones), base station device thereof, network related electronic devices such as servers and routers, and large computers.

In recent years, although a high-frequency electric signal is used in these products to transmit and process a large amount of information at high speed, an insulating material having excellent dielectric properties is required as an insulating material used for the printed wiring boards, the multilayer wiring boards, and the like in order to prevent transmission loss since the high-frequency signal is very easily attenuated.

An epoxy resin composition disclosed in Patent Literature 1 to 3 is known as the above insulating material. Patent Literature 1 discloses that an epoxy resin composition containing an epoxy resin, an active ester compound, and a triazine-containing cresol novolac resin is effective for reducing the dielectric loss tangent. Patent Literature 2 and 3 disclose that resin compositions containing an epoxy resin and an active ester compound as essential components can form a cured product having a low dielectric loss tangent and are useful as an insulating material. However, it has been found that these epoxy resin compositions are not satisfactory for high frequency band applications.

Meanwhile, Patent Literature 4 reports that a resin film formed of a resin composition containing a bismaleimide resin having a long chain alkyl group and a curing agent as a non-epoxy-based material is excellent in dielectric properties (low relative dielectric constant and low dielectric loss tangent). However, the problem is that the bismaleimide resin composed only of a long chain alkyldiamine has a low Tg and a low elastic modulus.

### CITATION LIST

### Patent Literature

Patent Literature 1: Japanese Unexamined Patent Publication No. 2011-132507
Patent Literature 2: Japanese Unexamined Patent Publication No. 2015-101626
Patent Literature 3: Japanese Unexamined Patent Publication No. 2017-210527
Patent Literature 4: WO 2016/114287 A

### SUMMARY OF INVENTION

### Technical Problem

The present inventors have studied a maleimide resin obtained using a dimer diamine and another amine as amines, as a maleimide resin capable of forming a cured product having a high elastic modulus and a high Tg while sufficiently maintaining a low dielectric constant and a low dielectric loss tangent.

An object of the present disclosure is to provide a novel method for producing a specific maleimide resin. In particular, an object of the present disclosure is to provide a method for producing a maleimide resin capable of improving the storage stability of a resin composition.

### Solution to Problem

In order to achieve the above object, the present disclosure provides the following method for producing a maleimide resin.
[1] A method for producing a maleimide resin by reacting a tetracarboxylic dianhydride (a1), an amine (a2), and a maleic anhydride (a3), the method including the steps of: adding the amine (a2) to the tetracarboxylic dianhydride (a1) in the presence of an organic solvent to obtain a polyimide resin; and adding the maleic anhydride (a3) to the polyimide resin to obtain the maleimide resin; wherein the organic solvent includes at least one of γ-butyrolactone and N-ethyl-2-pyrrolidone, and the amine (a2) includes a dimer diamine and a second amine other than the dimer diamine.
[2] The method for producing a maleimide resin according to [1], wherein at least one of the tetracarboxylic dianhydride (a1) and the amine (a2) includes a compound having a fluorene skeleton.
[3] The method for producing a maleimide resin according to [1] or [2], wherein the tetracarboxylic dianhydride (a1) includes at least one of 1,3,3a,4,5,9b-hexahydro-5-(tetrahydro-2,5-dioxo-3-furanyl) naphtho[1,2-c]furan-1,3-dione, 9,9-bis(3,4-dicarboxyphenyl) fluorene dianhydride, 9,9-bis[4-(3,4-dicarboxyphenoxy)phenyl]fluorene dianhydride, and 3,3′,4,4′-biphenyltetracarboxylic dianhydride.
[4] The method for producing a maleimide resin according to any one of [1] to [3], wherein the second amine contains at least one of norbornanediamine, 9,9-bis[4-(4-aminophenoxy)phenyl]fluorene, and 9,9-bis(4-aminophenyl) fluorene.
[5] The method for producing a maleimide resin according to any one of [1] to [4], in which the dimer diamine contains at least one of a compound represented by the following General Formula (1) and a compound represented by the following General Formula (2):

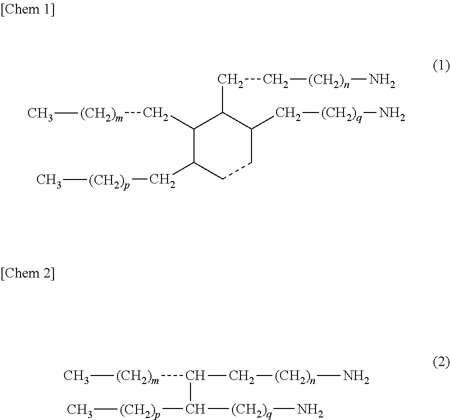

[in Formulas (1) and (2), m, n, p, and q each represent an integer of 1 or more selected so as to satisfy m+n=6 to 17 and p+q=8 to 19, and a bond indicated by a broken line represents a carbon-carbon single bond or a carbon-carbon double bond, and
provided that when the bond indicated by the broken line is a carbon-carbon double bond, Formulas (1) and (2) have a structure in which the number of hydrogen atoms bonded to each carbon atom constituting the carbon-carbon double bond is subtracted by one from the numbers indicated in Formulas (1) and (2)].
[6] The method for producing a maleimide resin according to any one of [1] to [5], wherein 0.30 to 1.00 mol of the tetracarboxylic dianhydride (a1) is reacted with 1.00 mol of the amine (a2).
[7] The method for producing a maleimide resin according to any one of [1] to [6], wherein the organic solvent further includes an aromatic hydrocarbon having a boiling point of 150° C. or higher.
[8] The method for producing a maleimide resin according to any one of [1] to [7], wherein the organic solvent further includes an alcohol having a boiling point of 100° C. or lower.
[9] The method for producing a maleimide resin according to any one of [1] to [8], wherein a content of the γ-butyrolactone and the N-ethyl-2-pyrrolidone in the organic solvent is 5 to 40 mass % based on a total amount of the organic solvent.

### Advantageous Effects of Invention

According to the present disclosure, a novel method for producing a specific maleimide resin can be provided. In particular, according to the present disclosure, a method for producing a maleimide resin capable of improving the storage stability of a resin composition can be provided. The maleimide resin produced by the method for producing a maleimide resin of the present disclosure and the resin composition (adhesive composition) containing the maleimide resin can have both a reduced dielectric constant and a reduced dielectric loss tangent (hereinafter, both may be collectively referred to as “dielectric properties”), are excellent in low dielectric properties particularly in a high frequency band, and can form a cured product having a high elastic modulus and a high Tg. Since the cured product (adhesive layer) obtained from the resin composition has a high elastic modulus and a high Tg, the resin composition is useful not only as an adhesive used for producing printed circuit boards (build-up substrates, flexible printed wiring boards, and the like) and a copper clad board for a printed wiring board, but also as an insulating film such as a redistribution layer, a semiconductor interlayer material, a coating agent, a resist ink, a conductive paste, and the like.

### BRIEF DESCRIPTION OF DRAWINGS

FIG. 1 is an IR spectrum of a maleimide resin (A-1) synthesized in Example 1.

FIG. 2 is an IR spectrum of a maleimide resin (A-2) synthesized in Example 2.

### DESCRIPTION OF EMBODIMENTS

Hereinafter, preferred embodiments of the present disclosure will be described in detail. However, the present disclosure is not limited to the following embodiments, and various modifications can be made within the scope of the gist of the present disclosure.

In the present specification, a numerical range indicated using “to” indicates a range including numerical values described before and after “to” as a minimum value and a maximum value, respectively. In a numerical range described in stages in the present specification, an upper limit value or a lower limit value of a numerical range of a certain stage can be arbitrarily combined with an upper limit value or a lower limit value of a numerical range of another stage. In the numerical range described in the present specification, the upper limit value or the lower limit value of the numerical range may be replaced with a value shown in Examples. “A or B” may include either A or B, or may include both A and B. The materials exemplified in the present specification can be used alone or in combination with two or more kinds thereof unless otherwise specified. When a plurality of materials corresponding to the respective components are present in the composition, a content of each component in the composition means the total amount of the plurality of materials present in the composition unless otherwise specified. In the present specification, the “solid content” refers to a non-volatile content excluding volatile substances (water, a solvent, or the like) included in a resin composition, and also includes a component in a liquid, syrupy, or waxy state at room temperature (around 25° C.).

### <Method for Producing Maleimide Resin>

The method for producing a maleimide resin of the present embodiment is a method for producing a maleimide resin by reacting a tetracarboxylic dianhydride (a1) (hereinafter, also referred to as “component (a1)”), an amine (a2) (hereinafter, also referred to as “component (a2)”), and a maleic anhydride (a3) (hereinafter, also referred to as “component (a3)”), the method including the steps of: adding the amine (a2) to the tetracarboxylic dianhydride (a1) in the presence of an organic solvent to obtain a polyimide resin; and adding the maleic anhydride (a3) to the polyimide resin to obtain the maleimide resin. Here, the organic solvent includes at least one of γ-butyrolactone and N-ethyl-2-pyrrolidone. The amine (a2) includes a dimer diamine and a second amine other than the dimer diamine.

### (Component (a1): Tetracarboxylic Dianhydride)

As the tetracarboxylic dianhydride as the component (a1), those known as a raw material of polyimide can be used. Examples of the component (a1) include pyromellitic anhydride, 4,4′-(hexafluoroisopropylidene)diphthalic anhydride, 1,3,3a,4,5,9b-hexahydro-5-(tetrahydro-2,5-dioxo-3-furanyl) naphtho[1,2-c]furan-1,3-dione, 4,4′-oxydiphthalic dianhydride, 3,3′,4,4′-diphenylsulfonetetracarboxylic dianhydride, 3,3′,4,4′-biphenyltetracarboxylic dianhydride, 3,3′,4,4′-benzophenonetetracarboxylic dianhydride, 4,4′-(4,4′-isopropylidenediphenoxy)diphthalic anhydride, 1,2,3,4-butanetetracarboxylic dianhydride, 1,2,3,4-cyclobutane tetracarboxylic dianhydride, 1,2,3,4-cyclopentane tetracarboxylic dianhydride, 1,2,3,4-tetramethyl-1,2,3,4-cyclobutane tetracarboxylic dianhydride, bicyclo[2.2.2]oct-7-ene-2,3,5,6-tetracarboxylic dianhydride, bis(1,3-dioxo-1,3-dihydroisobenzofuran-5-carboxylic acid) 1,4-phenylene, 9,9-bis(3,4-dicarboxyphenyl) fluorene dianhydride, 4,4′-(ethyne-1,2-diyl)diphthalic anhydride, 5-(2,5-dioxotetrahydrofuryl)-3-methyl-3-cyclohexene-1,2-dicarboxylic anhydride, dicyclohexyl-3,4,3′,4′-tetracarboxylic dianhydride, 3,4′-oxydiphthalic anhydride, 3,4′-biphthalic anhydride, norbornane-2-spiro-α-cyclopentanone-α′-spiro-2″-norbornane-5,5″,6,6″-tetracarboxylic dianhydride, 5,5′-bis-2-norbornene-5,5′,6,6′-tetracarboxylic acid-5,5′,6,6′-dianhydride, and 9,9-bis[4-(3,4-dicarboxyphenoxy)phenyl]fluorene dianhydride. The components (a1) can be used alone or in combination with two or more kinds thereof.

From the viewpoint of low dielectric properties, high Tg or low coefficient of thermal expansion (CTE), the component (a1) preferably contains at least one selected from the group consisting of 1,3,3a,4,5,9b-hexahydro-5-(tetrahydro-2,5-dioxo-3-furanyl) naphtho[1,2-c]furan-1,3-dione, 9,9-bis(3,4-dicarboxyphenyl) fluorene dianhydride, 3,3′,4,4′-biphenyltetracarboxylic dianhydride, 4,4′-(4,4′-isopropylidenediphenoxy)diphthalic anhydride, 4,4′-(hexafluoroisopropylidene)diphthalic anhydride, 5-(2,5-dioxotetrahydrofuryl)-3-methyl-3-cyclohexene-1,2-dicarboxylic anhydride, dicyclohexyl-3,4,3′,4′-tetracarboxylic dianhydride, bicyclo[2.2.2]octane-2,3,5,6-tetracarboxylic 2,3:5,6-dianhydride, 5,5′-bis-2-norbornene-5,5′,6,6′-tetracarboxylic acid-5,5′,6,6′-dianhydride, 3,4′-biphthalic anhydride, and 9,9-bis[4-(3,4-dicarboxyphenoxy)phenyl]fluorene dianhydride, more preferably contains at least one selected from the group consisting of 1,3,3a,4,5,9b-hexahydro-5-(tetrahydro-2,5-dioxo-3-furanyl) naphtho[1,2-c]furan-1,3-dione, 9,9-bis(3,4-dicarboxyphenyl) fluorene dianhydride, 4,4′-(4,4′-isopropylidenediphenoxy)diphthalic anhydride, 4,4′-(hexafluoroisopropylidene)diphthalic anhydride, 9,9-bis[4-(3,4-dicarboxyphenoxy)phenyl]fluorene dianhydride, and 3,3′,4,4′-biphenyltetracarboxylic dianhydride, and still more preferably contains at least one of 1,3,3a,4,5,9b-hexahydro-5-(tetrahydro-2,5-dioxo-3-furanyl) naphtho[1,2-c]furan-1,3-dione, 9,9-bis(3,4-dicarboxyphenyl) fluorene dianhydride, 9,9-bis[4-(3,4-dicarboxyphenoxy)phenyl]fluorene dianhydride, and 3,3′,4,4′-biphenyltetracarboxylic dianhydride.

The component (a2) contains a dimer diamine (first amine) and a second amine other than the dimer diamine.

The dimer diamine is, for example, a compound derived from a dimer acid which is a dimer of an unsaturated fatty acid such as oleic acid as described in Japanese Unexamined Patent Publication No. H9-12712. By using a dimer diamine as the component (a2), a cured product having reduced dielectric properties can be obtained. In the present embodiment, a known dimer diamine can be used without particular limitation. The dimer diamine preferably includes, for example, at least one of a compound represented by the following General Formula (1) and a compound represented by the following General Formula (2).

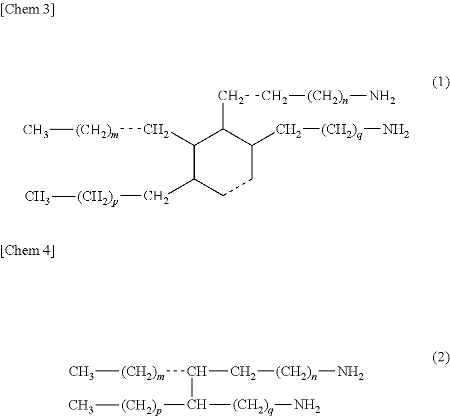

[in Formulas (1) and (2), m, n, p, and q each represent an integer of 1 or more selected so as to satisfy m+n=6 to 17 and p+q=8 to 19, and a bond indicated by a broken line represents a carbon-carbon single bond or a carbon-carbon double bond, and
provided that when the bond indicated by the broken line is a carbon-carbon double bond, Formulas (1) and (2) have a structure in which the number of hydrogen atoms bonded to each carbon atom constituting the carbon-carbon double bond is subtracted by one from the numbers indicated in Formulas (1) and (2)].

The dimer diamine may be a diamine represented by General Formula (2) from the viewpoint of solubility in an organic solvent, heat resistance, heat resistant adhesiveness, low viscosity, and the like, and may be particularly a compound represented by the following Formula (3).

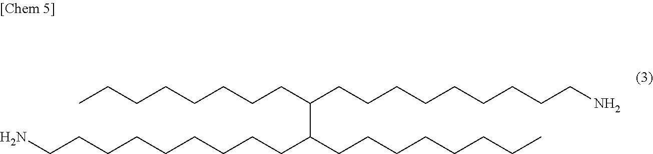

Examples of a commercially available product of the dimer diamine include PRIAMINE 1075 and PRIAMINE 1074 (both manufactured by Croda Japan K.K.). The commercially available products of the dimer diamine can be used alone or in combination with two or more kinds thereof.

The second amine is an amine that does not correspond to the dimer diamine described above. The second amine may be a diamine or a triamine, or may be a diamine. By using an alicyclic diamine as the second amine, a dielectric constant can be further reduced. By using an aromatic diamine as the second amine, an elastic modulus, Tg, and CTE of the cured product are improved.

When the second amine is a diamine, examples of the diamine include 1,3-diaminopropane, norbornanediamine, 4,4-methylenedianiline, 1,3-bis[2-(4-aminophenyl)-2-propyl]benzene, 4,4′-diamino-2,2′-bis(trifluoromethyl) biphenyl, 2,2-bis[4-(4-aminophenoxy)phenyl]hexafluoropropane, 9,9-bis(4-aminophenyl)fluorene, 9,9-bis[3-fluoro-4-aminophenyl]fluorene, 9,9-bis[4-(4-aminophenoxy)phenyl]fluorene, 1,3-bis(aminomethyl)cyclohexane, 1,4-bis(aminomethyl)cyclohexane, bis(aminomethyl) norbornane, 4,4′-(hexafluoroisopropylidene)dianiline, 3 (4),8 (9)-bis(aminomethyl)tricyclo[5.2.1.0^{2,6}]decane, 1,3-cyclohexanediamine, 1,4-cyclohexanediamine, isophoronediamine, 4,4′-methylenebis(cyclohexylamine), 4,4′-methylenebis(2-methylcyclohexylamine), 1,1-bis(4-aminophenyl)cyclohexane, 2,7-diaminofluorene, 4,4′-ethylenedianiline, 4,4′-methylenebis(2,6-diethylaniline), 4,4′-methylenebis(2-ethyl-6-methylaniline), 2,2-bis[4-(4-aminophenoxy)phenyl]propane, bis[4-(4-aminophenoxy)phenyl]methane, 4,4′-bis(4-aminophenoxy) biphenyl, bis[4-(4-aminophenoxy)phenyl]ether, bis[4-(4-aminophenoxy)phenyl]ketone, 1,3-bis(4-aminophenoxy)benzene, 1,4-bis(4-aminophenoxy)benzene, 2,2′-dimethylbiphenyl-4,4′-diamine, (4,4′-diamino)diphenyl ether, (3,3′-diamino)diphenyl ether, paraphenylenediamine, orthophenylenediamine, meta-phenylenediamine, 2,2′-dimethylbiphenyl-4,4′-diamine, bis[4-(3-aminophenoxy)phenyl]sulfone, and bis[4-(4-aminophenoxy)phenyl]sulfone. The diamines can be used alone or in combination with two or more kinds thereof.

When the second amine is a triamine, examples of the triamine include tris(aminomethyl)amine, tris(2-aminoethyl)amine, tris(2-aminopropyl)amine, 2-(aminomethyl)-2-methyl-1,3-propanediamine, a trimer triamine, 3,4,4′-triaminodiphenyl ether, 1,2,4-triaminobenzene, 1,3,5-triaminobenzene, 1,2,3-triaminobenzene, 1,3,5-triazine-2,4,6-triamine, 2,4,6-triaminopyrimidine, 1,3,5-tris(4-aminophenyl)benzene, and 1,3,5-tris(4-aminophenoxy)benzene. The triamines can be used alone or in combination with two or more kinds thereof. Among them, from the viewpoint of the solubility of the synthesized maleimide resin in an organic solvent, an aliphatic triamine is preferable, and tris(aminomethyl)amine and tris(2-aminoethyl)amine having a small number of carbon atoms are more preferable from the viewpoint of a high Tg.

The second amine may include one or both of the diamine and triamine described above. The second amine may also include an amine other than the diamine and the triamine.

From the viewpoint of high Tg, high elastic modulus, and low CTE, the second amine preferably contains at least one of norbornanediamine, 9,9-bis[4-(4-aminophenoxy)phenyl]fluorene, and 9,9-bis(4-aminophenyl) fluorene.

In the component (a2), a molar ratio of the second amine to the total amount of the amines (the number of moles of the second amine/(the number of moles of the dimer diamine+the number of moles of the second amine)) may be 70 mol % or less or 50 mol % or less. When the ratio is 70 mol % or less, the dielectric properties of the cured product can be further lowered.

When the second amine includes a diamine, in the component (a2), a molar ratio of the diamine in the second amine to the total amount of the diamines (the number of moles of the diamine in the second amine/(the number of moles of the dimer diamine+the number of moles of the diamine in the second amine)) may be 70 mol % or less or 50 mol % or less. When the ratio is 70 mol % or less, the dielectric properties of the cured product can be further lowered.

By using a dimer diamine as the diamine, a cured product having reduced dielectric properties can be obtained. On the other hand, when only a dimer diamine is used as the amine, an elastic modulus and a Tg of the cured product decrease. On the other hand, when the second amine, particularly a diamine other than the dimer diamine is used in combination with the dimer diamine, the elastic modulus and Tg can be improved while maintaining the dielectric properties of the cured product.

At least one of the component (a1) and the component (a2) described above may include a compound having a fluorene skeleton. When at least one of the component (a1) and the component (a2) constituting the maleimide resin includes a compound having a fluorene skeleton, a cured product obtained using the maleimide resin has a high elastic modulus, a high Tg, and a low CTE while sufficiently maintaining a low dielectric constant and a low dielectric loss tangent. From the viewpoint of further increasing the elastic modulus and Tg and decreasing the CTE of the cured product, both the component (a1) and the component (a2) described above may include a compound having a fluorene skeleton.

The maleimide resin can be produced by the following method. For example, first, the component (a1) and the component (a2) are subjected to a polyaddition reaction at a temperature of about 60 to 120° C. and preferably 70 to 90° C., for usually about 0.1 to 2 hours and preferably 0.1 to 1.0 hour. Next, the obtained polyaddition product is further subjected to an imidization reaction, that is, a dehydration ring closing reaction, at a temperature of about 80 to 250° C., preferably 100 to 200° C., for about 0.5 to 30 hours, preferably 0.5 to 10 hours (imidization step). The imidization step is performed in the presence of an organic solvent including at least one of γ-butyrolactone and N-ethyl-2-pyrrolidone. Subsequently, the product obtained by the dehydration ring closing reaction and the component (a3) are subjected to a maleimidation reaction, that is, a dehydration ring closing reaction, at a temperature of about 60 to 250° C. and preferably 80 to 200° C. for about 0.5 to 30 hours and preferably 0.5 to 10 hours (maleimidation step). As a result, the target maleimide resin is obtained. The polyaddition reaction, the imidization reaction, and the maleimidation reaction may be performed under any condition of atmospheric pressure (normal pressure), under reduced pressure, or under pressure.

The organic solvent used in the present embodiment includes at least one of γ-butyrolactone and N-ethyl-2-pyrrolidone. By using at least one of γ-butyrolactone and N-ethyl-2-pyrrolidone, a maleimide resin capable of improving the storage stability of the resin composition can be produced. Here, it is considered that the storage stability of the resin composition can be improved because a maleimide resin having a low amine value can be obtained by using the organic solvent, whereby the reaction in the resin composition can be suppressed.

From the viewpoint of further improving the storage stability of the resin composition, the organic solvent preferably includes γ-butyrolactone and N-ethyl-2-pyrrolidone in a content (the total content when the organic solvent includes both γ-butyrolactone and N-ethyl-2-pyrrolidone) of 5 mass % or more, more preferably 8 to 40 mass %, and particularly preferably 8 to 25 mass %, based on the total amount of the organic solvent.

The organic solvent may be a mixed solvent including a plurality of organic solvents, and the mixed solvent may include an organic solvent other than γ-butyrolactone and N-ethyl-2-pyrrolidone. The mixed solvent preferably includes an aromatic hydrocarbon having a boiling point of 150° C. or higher from the viewpoint that the component (a1) and the component (a2) can be easily dissolved in the mixed solvent, the reaction time of the dehydration ring closing reaction can be shortened in the imidization step and the maleimidation step, and the maleimide resin can be synthesized in a short time. In addition, the mixed solvent preferably includes an alcohol having a boiling point of 100° C. or lower from the viewpoint of being able to half-esterify the component (a1). When the component (a1) is half-esterified, the component (a1) is easily dissolved in the mixed solvent, and can promote the dehydration ring closing reaction in the imidization step and can suppress side reactions. In addition, use of an alcohol at 100° C. or lower promotes desorption of the alcohol component at the time of the dehydration ring closing reaction in the imidization step, can improve the ring closing rate in the imidization, and can also shorten the reaction time. The boiling point in the present specification means a boiling point under atmospheric pressure (1,013 hPa).

Examples of the aromatic hydrocarbon having a boiling point of 150° C. or higher include solvent naphtha, mesitylene, 1,2,3-trimethylbenzene, 1,2,4-trimethylbenzene (pseudocumene), and tetralin. Among them, solvent naphtha, mesitylene, and pseudocumene are preferable from the viewpoint of boiling point. The aromatic hydrocarbons can be used alone or in combination with two or more kinds thereof.

The aromatic hydrocarbon has a boiling point of 150° C. or higher, but the boiling point may be 155° C. or higher or 160° C. or higher from the viewpoint of efficiently performing synthesis in a shorter time. Meanwhile, from the viewpoint of further reducing the amount of the solvent remaining in the synthesized maleimide resin, the boiling point of the aromatic hydrocarbon may be 210° C. or lower, 200° C. or lower, or 180° C. or lower.

Examples of the alcohol having a boiling point of 100° C. or lower include methanol, ethanol, 1-propanol, and isopropanol. The alcohols can be used alone or in combination with two or more kinds thereof. In particular, among them, methanol and ethanol are particularly preferable from the viewpoint of ease of desorption during imide ring closure. Here, the ease of hydrolysis of the ester generally depends on the number of carbon atoms (boiling point) of the alcohol, and the alcohol having a lower boiling point has higher desorption ability and is easily desorbed at the time of imide ring closure. Therefore, methanol and ethanol are preferable as the alcohol.

The mixed solvent may include a solvent other than the above solvents. Examples of the other solvent include methyl ethyl ketone, methyl isobutyl ketone, toluene, xylene, ethylene glycol monomethyl ether, N,N′-dimethylformamide, N-methylcaprolactam, methyl triglyme, methyl diglyme, 1-butanol, benzyl alcohol, cresol, propylene glycol monomethyl ether, methyl isobutyl carbinol, 1-propoxy-2-propanol, cyclopentanone, cyclohexanone, and methylcyclohexane. The other solvents can be used alone or in combination with two or more kinds thereof. These other solvents may be contained in the mixed solvent in a content of 10 mass % or less based on the total amount of the mixed solvent.

In the imidization reaction or the maleimidation reaction, various known reaction catalysts, dehydrating agents, and the like can be used. Examples of the reaction catalyst include aliphatic tertiary amines such as triethylamine, aromatic tertiary amines such as dimethylaniline, heterocyclic tertiary amines such as pyridine, picoline, and isoquinoline, and organic acids such as methanesulfonic acid and paratoluenesulfonic acid monohydrate. The reaction catalysts can be used alone or in combination with two or more kinds thereof. Examples of the dehydrating agent include aliphatic acid anhydrides such as acetic anhydride and aromatic acid anhydrides such as benzoic anhydride. The dehydrating agents can be used alone or in combination with two or more kinds thereof.

The production method of the present embodiment may include a water washing step of washing with water and purifying the obtained maleimide resin after the maleimidation step. The water washing can be performed by adding the obtained maleimide resin together with an organic solvent into water, stirring the mixture, separating the stirred mixed solution into an aqueous layer and an oil layer (organic layer), and removing the aqueous layer. This series of operations may be repeated twice or more. The water washing may be performed at a liquid temperature of 50 to 100° C. By performing the water washing step, ionic impurities can be removed. The oil layer including the recovered maleimide resin can be heated to remove water. The maleimide resin from which water has been removed can be heated to remove the solvent. This solvent may be removed under reduced pressure. The solvent can be removed in a pressure reduction state in which the pressure is reduced from atmospheric pressure by 0.06 to 0.10 MPa by heating at a temperature of 80 to 150° C. for 0.2 to 10.0 hours.

The maleimide resin obtained by the production method of the present embodiment may have a plurality of maleimide groups in the molecule. The maleimide resin may be a bismaleimide resin. An assumed structure of the maleimide resin produced by the above method is shown in the following General Formula (4). The General Formula (4) is based on the assumption that the second amine is a diamine.

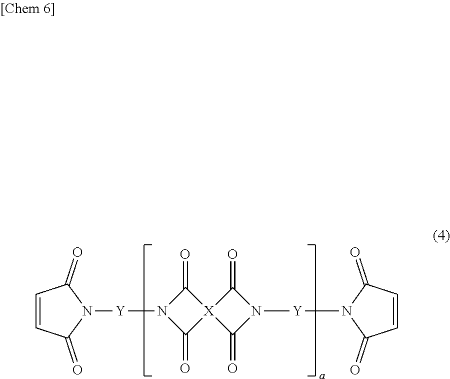

In the General Formula (4), X's each independently represent a tetravalent organic group, Y's each independently represent a divalent organic group, and a represents an integer of 1 or more. However, at least one of the plurality of Y's represents a divalent organic group derived from the dimer diamine described above, and at least one of the plurality of Y's represents a divalent organic group derived from the second amine (diamine) described above. X and Y may be organic groups having an aliphatic group, an alicyclic structure, or an aromatic ring, and may contain a heteroatom. Furthermore, at least one of X and Y may be an organic group having a fluorene skeleton.

A molecular weight of the maleimide resin can be controlled by the numbers of moles of the component (a1) and the component (a2), and the molecular weight can be made smaller as the number of moles of the component (a1) is smaller than the number of moles of the component (a2). For the purpose of easily achieving the effect of the present disclosure, the number of moles of the component (a1) with respect to 1.00 moles of the component (a2), that is, [the number of moles of the component (a1)]/[the number of moles of the component (a2)] is usually in a range of about 0.30 to 1.00, preferably 0.30 to 0.95, more preferably 0.30 to 0.90, and still more preferably 0.50 to 0.80.

From the viewpoint of the solubility in a solvent and heat resistance, the maleimide resin preferably has a molecular weight of 3,000 to 30,000, more preferably 3,000 to 25,000, still more preferably 5,000 to 23,000, and particularly preferably 7,000 to 20,000 in terms of weight average molecular weight (Mw). When the weight average molecular weight is 30,000 or less, the solubility in an organic solvent is improved, and when the weight average molecular weight is 3,000 or more, an effect of improving heat resistance tends to be sufficiently obtained. The Mw can be measured by gel permeation chromatography (GPC), and can be converted using a calibration curve of standard polystyrene.

The maleimide resin preferably has an amine value of 1.5 mgKOH/g or less, more preferably 1.0 mgKOH/g or less, and particularly preferably 0.6 mgKOH/g or less from the viewpoint of enhancing the storage stability of the resin composition including the maleimide resin. A maleimide resin having a reduced amine value can be produced by the production method of the present embodiment.

### <Resin Composition>

The maleimide resin can be used as a resin composition. The resin composition may be a photosensitive resin composition. In this case, this photosensitive resin composition is applied onto a substrate and dried to form a resin film, and the resin film is exposed and developed to obtain a patterned resin film (a resin film on which a pattern is formed). Then, a patterned cured film (cured film on which a pattern is formed) can be formed by thermally curing the patterned resin film, and the patterned cured film can be used as an insulating film. Hereinafter, a case where the resin composition is a photosensitive resin composition will be described.

The photosensitive resin composition includes the maleimide resin (hereinafter, also referred to as “component (A)”). The maleimide resins can be used alone or in combination with two or more thereof for the photosensitive resin composition. The photosensitive resin composition may further include a crosslinking agent and a photopolymerization initiator. The photosensitive resin composition may further contain a thermal polymerization initiator, a coupling agent, a rust inhibitor, a polymerization inhibitor, and the like, as necessary. The photosensitive resin composition according to the present embodiment is a negative photosensitive resin composition, and a cured product of the photosensitive resin composition can be suitably used as an insulating film for a redistribution layer. Hereinafter, each component used in the photosensitive resin composition of the present embodiment will be described in more detail.

### (Crosslinking Agent)

The crosslinking agent (hereinafter, also referred to as “component (B)”) may be a polymerizable crosslinking agent. The polymerizable group may be a photopolymerizable group or a thermopolymerizable group. Examples of the polymerizable group include a (meth)acryloyl group, an allyl group, and a vinyl group. The component (B) may be a polyfunctional compound having two or more polymerizable groups. The component (B) can be crosslinked, for example, not only with other crosslinking agents but also with the component (A) during exposure of the resin composition. In addition, the component (B) can be crosslinked, for example, with other polymerizable crosslinking agents at the time of heating of the resin film after pattern formation. The components (B) can be used alone or in combination with two or more kinds thereof.

The resin composition according to the present embodiment may contain a polymerizable crosslinking agent having a (meth)acryloyl group as a crosslinking agent from the viewpoint of dielectric properties. The polymerizable crosslinking agent having a (meth)acryloyl group can crosslink with other crosslinking agents and can be crosslinked with the component (A) at the time of exposure of the photosensitive layer. The polymerizable crosslinking agent having a (meth)acryloyl group may be an acrylate compound or a methacrylate compound. The component (B) may include a methacrylate compound from the viewpoint of dielectric properties.

Examples of the polymerizable crosslinking agent having a (meth)acryloyl group include tricyclodecanedimethanol di(meth)acrylate, tris(2-(meth)acryloyloxyethyl) isocyanurate, dioxane glycol di(meth)acrylate, alkoxylated glycerin tri(meth)acrylate, trimethylolpropane tri(meth)acrylate, alkoxylated trimethylolpropane tri(meth)acrylate, pentaerythritol tri(meth)acrylate, pentaerythritol tetra(meth)acrylate, alkoxylated pentaerythritol tetra(meth)acrylate, 1,6-hexanediol di(meth)acrylate, 1,9-nonanediol di(meth)acrylate, 1,10-decanediol di(meth)acrylate, neopentyl glycol di(meth)acrylate, ethoxylated bisphenol A di(meth)acrylate, propoxylated ethoxylated bisphenol A (meth)acrylate, dipentaerythritol poly(meth)acrylate, alkoxylated dipentaerythritol poly(meth)acrylate, ethoxylated isocyanuric acid tri(meth)acrylate, polyethylene glycol di(meth)acrylate, and polypropylene glycol di(meth)acrylate.

The polymerizable crosslinking agent having a (meth)acryloyl group may include at least one selected from the group consisting of tricyclodecanedimethanol di(meth)acrylate, tris(2-(meth)acryloyloxyethyl) isocyanurate, and dioxane glycol di(meth)acrylate from the viewpoint of heat resistance, dielectric properties, and fine processability, and may include tris(2-(meth)acryloyloxyethyl) isocyanurate from the viewpoint of heat resistance and dielectric properties.

The resin composition according to the present embodiment may contain, as the crosslinking agent, a polymerizable crosslinking agent having an allyl group or a vinyl group from the viewpoint of dielectric properties and heat resistance. The polymerizable crosslinking agent having an allyl group or a vinyl group can crosslink with other polymerizable crosslinking agents at the time of heating the resin film after pattern formation.

Examples of the polymerizable crosslinking agent having an allyl group include 1,3,4,6-tetraallyl glycoluril, triallyl isocyanurate, diallyl monoglycidyl isocyanurate, diallyl monomethyl isocyanurate, diallyl isocyanurate, triallyl trimellitate, and triallyl ortho-formate.

Examples of the polymerizable crosslinking agent having a vinyl group include a polyvinyl benzyl compound and a polyvinyl benzyl ether compound.

The polymerizable crosslinking agent having an allyl group or a vinyl group may include at least one selected from the group consisting of 1,3,4,6-tetraallyl glycoluril, triallyl isocyanurate, diallyl isocyanurate, and a polyvinyl benzyl ether compound from the viewpoint of dielectric properties and fine processability, and may include triallyl isocyanurate.

From the viewpoint of further improving a balance between the low dielectric properties and the fine processability, a content of the component (B) is preferably less than 50 parts by mass, and may be 1 to 45 parts by mass, 5 to 40 parts by mass, 8 to 30 parts by mass, or 10 to 20 parts by mass, when the total amount of the components (A) and (B) is 100 parts by mass.

### (Photopolymerization Initiator)

The photopolymerization initiator (hereinafter, also referred to as “component (C)”) is not particularly limited as long as it is a compound that initiates polymerization by radiation with an active ray (ultraviolet ray or the like), and examples thereof include an alkylphenone-based photopolymerization initiator, an acylphosphine oxide-based photopolymerization initiator, an intramolecular hydrogen abstraction type photopolymerization initiator, and an oxime ester-based photopolymerization initiator.

The alkylphenone-based photopolymerization initiator can be purchased as, for example, Omnirad 651, Omnirad 184, Omnirad 1173, Omnirad 2959, Omnirad 127, Omnirad 907, Omnirad 369, or Omnirad 379EG manufactured by IGM Resins B.V., or the like. The acylphosphine oxide-based photopolymerization initiator can be purchased as, for example, Omnirad 819 or Omnirad TPO H manufactured by IGM Resins B.V., or the like. The intramolecular hydrogen abstraction type photopolymerization initiator can be purchased as, for example, Omnirad MBF or Omnirad 754 manufactured by IGM Resins B.V., or the like. The oxime ester-based photopolymerization initiator can be purchased as, for example, Irgacure OXE01 or Irgacure OXE02 manufactured by BASF Japan Ltd., or the like. In order to promote the photoreaction, a titanocene-based photopolymerization initiator (for example, Irgacure 784, manufactured by BASF Japan Ltd.) may be used in combination.

A content of the component (C) may be 0.1 to 10 parts by mass, 0.5 to 8 parts by mass, or 1 to 5 parts by mass, with respect to 100 parts by mass of the total amount of the component (A) and the component (B) in terms of easily obtaining excellent fine processability.

### (Thermal Polymerization Initiator)

The photosensitive resin composition according to the present embodiment may further contain a thermal polymerization initiator as the component (D) from the viewpoint of promoting a polymerization reaction of a thermally polymerizable crosslinking agent. As the component (D), a compound that is decomposed by heating during curing to generate radicals and promotes the polymerization reaction of the component (A) and the component (B) is preferable. Examples of the component (D) include an organic peroxide.

Examples of the organic peroxide include methyl ethyl ketone peroxide, methylcyclohexanone peroxide, methyl acetoacetate peroxide, acetylacetone peroxide, 1,1-bis(t-butylperoxy)-3,3,5-trimethylcyclohexane, 1,1-bis(t-hexylperoxy)cyclohexane, 1,1-bis(t-hexylperoxy)-3,3,5-trimethylcyclohexane, 1,1-bis(t-butylperoxy)cyclohexane, 2,2-bis(4,4-di-t-butylperoxycyclohexyl) propane, 1,1-bis(t-butylperoxy)cyclododecane, n-butyl 4,4-bis(t-butylperoxy) valerate, 2,2-bis(t-butylperoxy) butane, 1,1-bis(t-butylperoxy)-2-methylcyclohexane, t-butyl hydroperoxide, p-menthane hydroperoxide, 1,1,3,3-tetramethylbutyl hydroperoxide, t-hexylhydroperoxide, dicumyl peroxide, 2,5-dimethyl-2,5-bis(t-butylperoxy) hexane, α,α′-bis(t-butylperoxy)diisopropylbenzene, t-butylcumyl peroxide, di-t-butyl peroxide, 2,5-dimethyl-2,5-bis(t-butylperoxy) hexyne-3, isobutyryl peroxide, 3,5,5-trimethylhexanoyl peroxide, octanoyl peroxide, lauroyl peroxide, cinnamic acid peroxide, m-toluoyl peroxide, benzoyl peroxide, diisopropyl peroxydicarbonate, bis(4-t-butylcyclohexyl) peroxydicarbonate, di-3-methoxybutyl peroxydicarbonate, di-2-ethylhexyl peroxydicarbonate, di-sec-butyl peroxydicarbonate, di(3-methyl-3-methoxybutyl) peroxydicarbonate, di(4-t-butylcyclohexyl) peroxydicarbonate, α,α′-bis(neodecanoylperoxy)diisopropylbenzene, cumylperoxyneodecanoate, 1,1,3,3,-tetramethylbutylperoxyneodecanoate, 1-cyclohexyl-1-methylethyl peroxyneodecanoate, t-hexylperoxyneodecanoate, t-butylperoxyneodecanoate, t-hexylperoxypivalate, t-butylperoxypivalate, 2,5-dimethyl-2,5-bis(2-ethylhexanoylperoxy) hexane, 1,1,3,3-tetramethylbutylperoxy-2-ethylhexanoate, 1-cyclohexyl-1-methylethylperoxy-2-ethylhexanoate, t-hexylperoxy-2-ethylhexanoate, t-butylperoxy-2-ethylhexanoate, t-butylperoxyisobutyrate, t-butylperoxymaleic acid, t-butylperoxylaurate, t-butylperoxy-3,5,5-trimethylhexanoate, t-butylperoxyisopropyl monocarbonate, t-butylperoxy-2-ethylhexyl monocarbonate, 2,5-dimethyl-2,5-bis(benzoylperoxy) hexane, t-butylperoxyacetate, t-hexylperoxybenzoate, t-butylperoxy-m-toluoyl benzoate, t-butylperoxybenzoate, bis(t-butylperoxy) isophthalate, t-butylperoxyallyl monocarbonate, and 3,3′,4,4′-tetra(t-butylperoxycarbonyl)benzophenone.

A content of the component (D) is not particularly limited, and may be 0.1 to 10.0 parts by mass, 0.5 to 5.0 parts by mass, or 0.7 to 3.0 parts by mass, with respect to 100 parts by mass of the total amount of the component (A) and the component (B).

### (Coupling Agent)

The photosensitive resin composition according to the present embodiment may further contain a coupling agent from the viewpoint of improving the adhesion of the cured product of the photosensitive resin composition. The coupling agent may be a silane coupling agent. The silane coupling agent may have, for example, a group such as a vinyl group, an epoxy group, a styryl group, an acryloyl group, a methacryloyl group, an amino group, a ureido group, an isocyanate group, an isocyanurate group, or a mercapto group.

Examples of the silane coupling agent having a vinyl group include KBM-1003 and KBE-1003 (trade name, manufactured by Shin-Etsu Chemical Co., Ltd., the same applies hereinafter). Examples of the silane coupling agent having an epoxy group include KBM-303, 402, and 403, KBE-402 and 403, X-12-981S, and X-12-984S. Examples of the silane coupling agent having a styryl group include KBM-1403. Examples of the silane coupling agent having a methacryloyl group include KBM-502 and 503 and KBE-502 and 503. Examples of the silane coupling agent having an acryloyl group include KBM-5103, X-12-1048, and X-12-1050. Examples of the silane coupling agent having an amino group include KBM-602, 603, 903, 573, and 575, KBE-903 and 9103P, and X-12-972F. Examples of the silane coupling agent having a ureido group include KBE-585. Examples of the silane coupling agent having an isocyanate group include KBE-9007 and X-12-1159L. Examples of the silane coupling agent having an isocyanurate group include KBM-9659. Examples of the silane coupling agent having a mercapto group include KBM-802 and 803, X-12-1154, and X-12-1156. The silane coupling agent may be a silane coupling agent having a methacryloyl group. The silane coupling agents can be used alone or in combination with two or more kinds thereof.

A content of the silane coupling agent may be 0.01 to 10 parts by mass, 0.1 to 8 parts by mass, or 0.5 to 5 parts by mass, with respect to 100 parts by mass of the total amount of the component (A) and the component (B).

### (Rust Inhibitor)

The photosensitive resin composition according to the present embodiment may further contain a rust inhibitor from the viewpoint of suppressing corrosion of the copper wiring or preventing discoloration. Examples of the rust inhibitor include a triazole derivative such as benzotriazole and a tetrazole derivative. The rust inhibitors may be used alone or in combination with two or more kinds thereof.

A content of the rust inhibitor may be 0.01 to 10 parts by mass, 0.1 to 5 parts by mass, or 0.5 to 3 parts by mass, with respect to 100 parts by mass of the total amount of the component (A) and the component (B).

### (Polymerization Inhibitor)

The photosensitive resin composition according to the present embodiment may further contain a polymerization inhibitor from the viewpoint of storage stability.

Examples of the polymerization inhibitor include 4-tert-butylcatechol, 4-hydroxy-2,2,6,6-tetramethylpiperidine-1-oxy radical, p-methoxyphenol, diphenyl-p-benzoquinone, benzoquinone, hydroquinone, pyrogallol, phenothiazine, resorcinol, ortho-dinitrobenzene, para-dinitrobenzene, meta-dinitrobenzene, phenanthraquinone, N-phenyl-2-naphthylamine, cupferron, 2,5-toluquinone, tannic acid, para-benzylaminophenol, tris(4-tert-butyl-3-hydroxy-2,6-dimethylbenzyl) isocyanuric acid, and nitrosamines. The polymerization inhibitors may be used alone or in combination with two or more kinds thereof.

A content of the polymerization inhibitor may be 0.01 to 10 parts by mass, 0.05 to 5 parts by mass, or 0.10 to 2 parts by mass, with respect to 100 parts by mass of the total amount of the component (A) and the component (B).

### (Sensitizer)

The photosensitive resin composition of the present disclosure may further include a sensitizer from the viewpoint of achieving both maintenance of a residual film ratio in a wide range of exposure amount and excellent resolution.

Examples of the sensitizer component include Michler's ketone, benzoin, 2-methylbenzoin, benzoin methyl ether, benzoin ethyl ether, benzoin isopropyl ether, benzoin butyl ether, 2-t-butylanthraquinone, 1,2-benzo-9,10-anthraquinone, anthraquinone, methylanthraquinone, 4,4′-bis(diethylamino)benzophenone, acetophenone, benzophenone, thioxanthone, 1,5-acenaphthene, 2,2-dimethoxy-2-phenylacetophenone, 1-hydroxycyclohexyl phenyl ketone, 2-methyl-[4-(methylthio)phenyl]-2-morpholino-1-propanone, diacetyl benzyl, benzyldimethyl ketal, benzyldiethyl ketal, diphenyl disulfide, anthracene, phenanthrenequinone, riboflavin tetrabutyrate, acridine orange, erythrosine, phenanthrenequinone, 2-isopropylthioxanthone, 2,6-bis(p-diethylaminobenzylidene)-4-methyl-4-azacyclohexanone, 6-bis(p-dimethylaminobenzylidene)-cyclopentanone, 2,6-bis(p-diethylaminobenzylidene)-4-phenylcyclohexanone, aminostyryl ketone, a 3-ketocoumarin compound, a biscoumarin compound, N-phenylglycine, N-phenyldiethanolamine, and 3,3′,4,4′-tetra(t-butylperoxycarbonyl)benzophenone. The sensitizer components may be used alone or in combination with two or more kinds thereof.

When the photosensitive resin composition contains a sensitizer component, a blending amount thereof is preferably 0.1 to 2.0 parts by mass, and more preferably 0.2 to 1.5 parts by mass, with respect to 100 parts by mass of the component (A).

### (Solvent)

When the photosensitive resin composition according to the present embodiment contains a solvent for dissolving and dispersing each component, the photosensitive resin composition can be easily applied onto a substrate to form a coating film having a uniform thickness. The solvents may be used alone or in combination with two or more kinds thereof.

Examples of the solvent include ketones such as methyl ethyl ketone, cyclohexanone, and cyclopentanone; aromatic hydrocarbons such as toluene, xylene, tetramethylbenzene, and pseudocumene; glycol ethers such as methyl cellosolve, butyl cellosolve, methyl carbitol, butyl carbitol, propylene glycol monomethyl ether, dipropylene glycol monoethyl ether, dipropylene glycol dimethyl ether, dipropylene glycol diethyl ether, and triethylene glycol monoethyl ether; esters such as ethyl acetate, butyl acetate, butyl cellosolve acetate, carbitol acetate, and γ-butyrolactone; and nitrogen-containing compounds such as mesitylene, N,N-dimethylformamide, N,N-dimethylacetamide, N-methyl-2-pyrrolidone, N-ethyl-2-pyrrolidone, 3-methoxy-N,N-dimethylpropanamide, and 3-butoxy-N,N-dimethylpropanamide.

A blending amount of the solvent is not particularly limited, and may be an amount in which a solid content in the photosensitive resin composition is 5 to 60 mass %, 10 to 50 mass %, or 15 to 40 mass %.

The preparation means, conditions, and the like of the photosensitive resin composition are not particularly limited. Examples thereof include a method in which the respective main components are sufficiently uniformly stirred and mixed in predetermined blending amounts by a mixer or the like, and then kneaded by using a mixing roll, an extruder, a kneader, a roll, an extruder, or the like. The kneading method is not particularly limited.

A relative dielectric constant of the cured product of the photosensitive resin composition according to the present embodiment at 10 GHz may be 2.80 or less, 2.75 or less, or 2.70 or less. A dielectric loss tangent of the cured product of the photosensitive resin composition at 10 GHz may be 0.0060 or less, 0.0050 or less, 0.0045 or less, or 0.0040 or less. The relative dielectric constant and the dielectric loss tangent can be measured by the method described in Examples using a cured film of the photosensitive resin composition.

The photosensitive resin composition according to the present embodiment can form a fine pattern. The photosensitive resin composition according to the present embodiment can form an insulating film exhibiting low dielectric properties and excellent insulation reliability. A semiconductor element including an interlayer insulating layer formed using a cured product of the photosensitive resin composition described above, and an electronic device including the semiconductor element can be produced. The semiconductor element includes a redistribution layer including the cured product of the photosensitive resin composition according to the present embodiment, such that high frequency characteristics can be improved. The semiconductor element may be, for example, a memory, a package, or the like having a multilayer wiring structure, a redistribution structure, or the like. Examples of the electronic device include a mobile phone, a smartphone, a tablet device, a personal computer, and a hard disk suspension. By including a patterned cured film formed of the photosensitive resin composition of the present embodiment, it is possible to provide a semiconductor element and an electronic device having excellent reliability.

### EXAMPLES

Hereinafter, the present disclosure will be specifically described based on Examples, but the present disclosure is not limited thereto.

### Synthesis of Maleimide Resin

### Example 1

Into a 1 L flask vessel equipped with a condenser, a nitrogen inlet tube, a thermocouple, a stirrer, and a vacuum pump, 9,9-bis(3,4-dicarboxyphenyl) fluorene dianhydride (trade name “BPAF”, manufactured by JFE Chemical Corporation), pseudocumene (manufactured by Toyo Gosei Co., Ltd.), Solmix A-11 (trade name, manufactured by Japan Alcohol Trading Co., Ltd., alcohol-based solvent containing ethanol as a main agent), and γ-butyrolactone (manufactured by FUJIFILM Wako Pure Chemical Corporation) were introduced. After the introduction, the temperature was raised to 80° C. and kept warm for 0.5 hours, and a dimer diamine (DDA) (trade name: “PRIAMINE 1075”, manufactured by Croda Japan K.K.) was added dropwise. After the dropwise addition, norbornanediamine (NBDA) (manufactured by Mitsui Fine Chemicals, Inc.) was added dropwise. Thereafter, the mixture was kept at 80° C. for about 0.25 hours. After the heat retention, methanesulfonic acid aqueous solution (trade name “Lutropur MSA”, manufactured by BASF SE) was added to the mixture. Thereafter, the temperature was raised to 160° C. After the temperature was raised, the pressure was reduced from atmospheric pressure by 0.03 MPa, and a dehydration ring closing reaction was performed in a reduced pressure state at 160° C. for 2 hours to remove water and alcohol in the reaction liquid, thereby obtaining an intermediate polyimide resin (imidization step). Subsequently, the inside of the reaction vessel was brought to atmospheric pressure, the obtained polyimide resin was cooled to 130° C., maleic anhydride (manufactured by FUSO CHEMICAL CO., LTD.) was added, the temperature was raised to 160° C., a dehydration ring closing reaction was performed in a state where the pressure was reduced from the atmospheric pressure by 0.03 MPa at 160° C. for 4 hours, and water in the reaction liquid was removed, thereby obtaining a maleimide resin (maleimidation step). The blending amount (unit: part by mass) of each component is shown in Table 1. In Table 1, the blending amount of the non-volatile content of each component other than the organic solvent is shown.

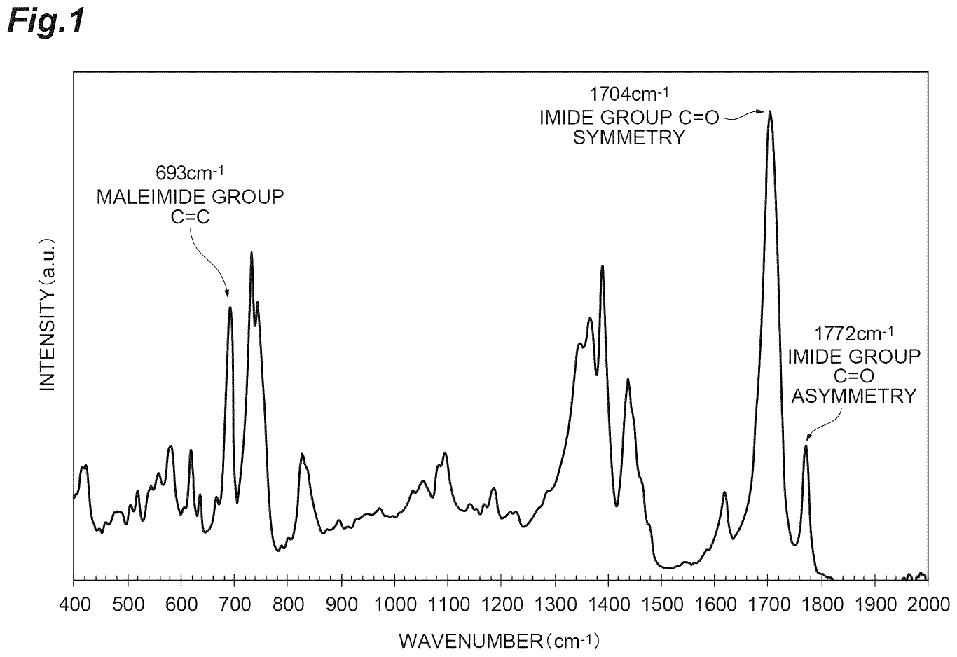

The obtained maleimide resin was placed in a separatory funnel, 500 parts by mass of pure water was added thereto, and the separatory funnel was shaken and allowed to stand. After the standing, an aqueous layer and an organic layer were separated, and then only the organic layer was recovered. The recovered organic layer was introduced into a 0.3 L glass vessel equipped with a condenser, a nitrogen inlet tube, a thermocouple, a stirrer, and a vacuum pump, the temperature was raised to 88 to 93° C., and then, water was removed. Thereafter, the temperature was raised to 100° C., and the solvent was partially removed for 0.5 hours in a state where the pressure was reduced from the atmospheric pressure by 0.1 MPa, thereby obtaining a solution of a maleimide resin (A-1) (non-volatile content: 40 mass %) as a component (A). The obtained maleimide resin (A-1) was subjected to IR measurement to confirm the production of a maleimide resin. The IR spectrum of the maleimide resin (A-1) is shown in FIG. 1. The IR spectrum was measured by setting a resin solid content obtained by drying the solution of the maleimide resin at 130° C. for 30 minutes in an FT-IR measuring apparatus (trade name “Alphall Platinum-ATR”, manufactured by Bruker) and subjecting the resin solid content to measurement.

### Example 2

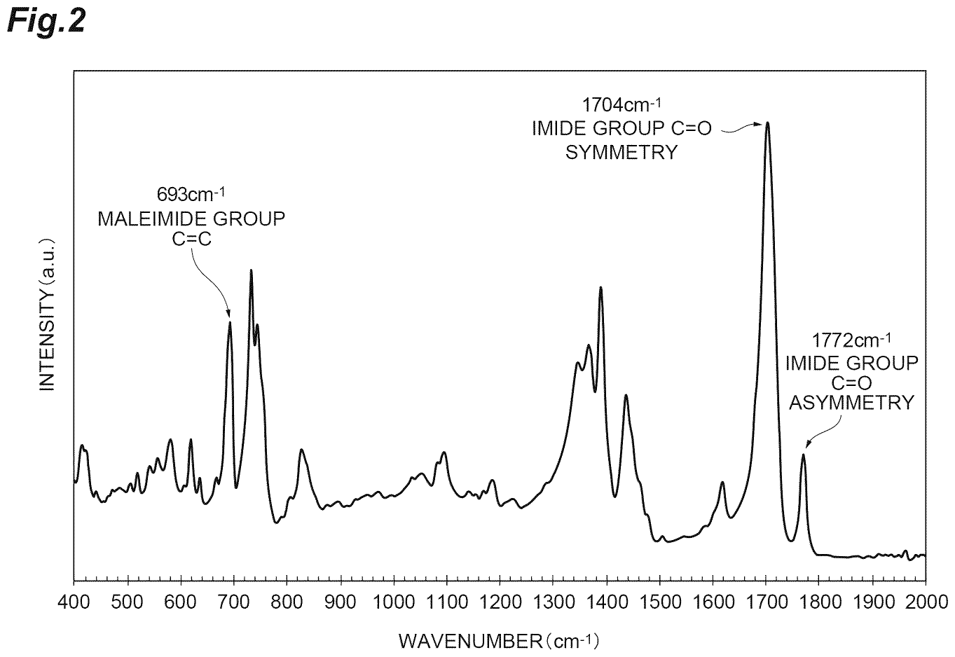

A solution of the maleimide resin (A-2) (non-volatile content: 40 mass %) as the component (A) was obtained in the same manner as in Example 1 except that N-ethyl-2-pyrrolidone (NEP) was used in place of γ-butyrolactone, and the blending amount of each component was changed to the amount shown in Table 1. The obtained maleimide resin (A-2) was subjected to IR measurement in the same manner as in Example 1 to confirm the production of a maleimide resin. The IR spectrum of the maleimide resin (A-2) is shown in FIG. 2.

### Example 3

A solution of the maleimide resin (A-3) (non-volatile content: 40 mass %) as the component (A) was obtained in the same manner as in Example 1 except that tris(2-aminoethyl)amine (TAEA) was used as an amine together with norbornanediamine (NBDA), and the blending amount of each component was changed to the amount shown in Table 1. The obtained maleimide resin (A-3) was subjected to IR measurement in the same manner as in Example 1 to confirm the production of a maleimide resin.

### Comparative Example 1

A solution of the maleimide resin (A-4) (non-volatile content: 40 mass %) as the component (A) was obtained in the same manner as in Example 1 except that γ-butyrolactone was not used as an organic solvent, and the blending amount of each component was changed to the amount shown in Table 1. The obtained maleimide resin (A-4) was subjected to IR measurement in the same manner as in Example 1 to confirm the production of a maleimide resin.

### Comparative Example 2

A solution of the maleimide resin (A-5) (non-volatile content: 40 mass %) as the component (A) was obtained in the same manner as in Example 3 except that γ-butyrolactone was not used as an organic solvent, and the blending amount of each component was changed to the amount shown in Table 1. The obtained maleimide resin (A-5) was subjected to IR measurement in the same manner as in Example 1 to confirm the production of a maleimide resin.

### <Measurement of Amine Value>

The maleimide resins obtained in Examples and Comparative Examples were dissolved in a solvent (mixed solvent of toluene and isopropyl alcohol (IPA) (volume ratio: 2:1)) so as to have a concentration of 11 mass %, thereby preparing a sample for amine value measurement. The obtained sample was set in an automatic potentiometric titrator (trade name “AT-710”, manufactured by Kyoto Electronics Manufacturing Co., Ltd.), and potentiometric titration was performed with 0.05 mol/L hydrochloric acid. The titration amount was obtained from the titration curve, and the amine value was calculated by the following formula. The results are shown in Table 1.

$$Amine value ( mg KOH / g ) = 0.05 \times f \times V \times 56.11 \times 1000 / W$$

f: factor of hydrochloric acid
V: titration amount (L)
W: solid content of maleimide resin (2.5 g)

### <Measurement of Weight Average Molecular Weight (Mw)>

A weight average molecular weight (Mw) of the maleimide resin obtained in Examples and Comparative Examples was measured by gel permeation chromatography (GPC). To columns (GL-R420×1, GL-R430×1, and GL-R440× 1 (all columns are manufactured by Hitachi High-Tech Fielding Corporation)) heated to 30° C., 50 μL of a sample obtained by dissolving the maleimide resin in tetrahydrofuran (THF) so as to have a concentration of 3 mass % was injected, and the measurement was performed under the condition of a flow rate of 1.6 mL/min using THE as a developing solvent. Note that, as a detector, L-3350 RI detector (manufactured by Hitachi, Ltd.) was used, and the Mw was converted from the elution time by a molecular weight/elution time curve created using standard polystyrene (manufactured by Tosoh Corporation). The results are shown in Table 1 as the initial Mw.

### <Preparation of Resin Composition>

To 85 parts by mass of the solution of the maleimide resin (non-volatile content: 40 mass %) obtained in Examples and Comparative Examples, 5 parts by mass of A-9300 (crosslinking agent), 10 parts by mass of TAIC (crosslinking agent), 3 parts by mass of OXE01 (photoinitiator), 2 parts by mass of OXE02 (photoinitiator), 1.7 parts by mass of PERBUTYL P (thermal initiator), 1.7 parts by mass of KBM-503 (silane coupling agent), 1.7 parts by mass of BT-120G (rust inhibitor), and 0.25 parts by mass of TEMPOL (polymerization inhibitor) were added and mixed, and cyclopentanone was added so that the non-volatile content was 40 mass % to obtain a resin composition. Details of each component are as follows.

A-9300: tris(2-acryloyloxyethyl) isocyanurate (trade name: “A-9300”, manufactured by SHIN-NAKAMURA CHEMICAL CO., LTD., number of acryloyl groups: 3)

TAIC: triallyl isocyanurate (trade name: “TAIC”, manufactured by Mitsubishi Chemical Corporation, number of allyl groups: 3)

OXE01: oxime ester-based photopolymerization initiator (trade name: “Irgacure OXE01”, manufactured by BASF Japan Ltd.)

OXE02: oxime ester-based photopolymerization initiator (trade name: “Irgacure OXE02”, manufactured by BASF Japan Ltd.)

PERBUTYL P: α,α′-bis(t-butylperoxy)diisopropylbenzene (trade name: “PERBUTYL P”, manufactured by NOF CORPORATION)

KBM-503:3-methacryloxypropyltrimethoxysilane (trade name “KBM-503”, manufactured by Shin-Etsu Chemical Co., Ltd.)

BT-120G: 1,2,3-benzotriazole (trade name “BT-120G”, manufactured by Johoku Chemical CO., LTD.)

TEMPOL: 4-hydroxy-2,2,6,6-tetramethylpiperidine-1-oxy radical (manufactured by Tokyo Chemical Industry Co., Ltd.)

### <Measurement of Viscosity>

In a sample holder of an E-type viscometer (trade name “RE-85”, manufactured by Toki Sangyo Co., Ltd.) adjusted to 25° C.±0.2° C., 1 mL of the resin composition prepared above was put, and the viscosity was measured. The results are shown in Table 1 as the initial viscosity.

### <Evaluation of Storage Stability>

The resin compositions prepared above were stored in a dark place at 25° C. For the resin compositions after storage for 360 hours and after storage for 720 hours, the Mw of the maleimide resins and the viscosity of the resin compositions were measured in the same manner as described above. Storage stability was evaluated from the obtained results based on the following criteria. The results are shown in Table 1.

### (Criteria)

A: In the change in the measured value after storage for 720 hours with respect to the initial value, the increase in Mw is less than 1000 and the increase in viscosity is less than 25 mPa·s.

B: The case does not correspond to the determination of A, and in the change in the measured value after storage for 720 hours with respect to the initial value, the increase in Mw is less than 1500 or the increase in viscosity is less than 40 mPa·s.

C: In the change in the measured value after storage for 720 hours with respect to the initial value, the increase in Mw is 1500 or more and the increase in viscosity is 40 mPa's or more.

TABLE 1

| | | | | | | Comparative | Comparative |
|---|---|---|---|---|---|---|---|
| | | | Example 1 | Example 2 | Example 3 | Example 1 | Example 2 |
| Content [part | Acid | BPAF | 96.28 | 96.20 | 27.50 | 36.79 | 26.27 |
| by mass] | dianhydride | | | | | | |
| | (a1) | | | | | | |
| | Amine | Dimer diamine | 90.21 | 90.21 | 29.53 | 34.47 | 28.20 |
| | (a2) | NBDA | 17.28 | 17.29 | 4.62 | 6.61 | 4.42 |
| | | TAEA | — | — | 1.46 | — | 1.40 |
| | Acid catalyst | Methanesulfonic | 3.79 | 3.79 | 2.49 | 1.44 | 3.41 |
| | | acid | | | | | |
| | Organic solvent | Pseudocumene | 385.55 | 385.30 | 120.84 | 147.11 | 120.56 |
| | | γ-butyrolactone | 90.50 | — | 43.00 | — | — |
| | | NEP | — | 90.30 | — | — | — |
| | | Solmix A-11 | 86.50 | 84.61 | 29.63 | 32.45 | 32.15 |
| | Maleic anhydride (a3) | | 20.59 | 20.59 | 11.76 | 7.89 | 11.24 |
| Evaluation | Amine value [mgKOH/g] | | 1.24 | 0.25 | 1.47 | 2.24 | 1.88 |
| | Mw | Initial | 9000 | 9000 | 9800 | 10500 | 12500 |
| | | After storage for | 9800 | 9000 | 10800 | 11700 | 15300 |
| | | 360 hours | | | | | |
| | | After storage for | 9800 | 9000 | 11000 | 12000 | 16000 |
| | | 720 hours | | | | | |
| | Viscosity | Initial | 220 | 200 | 430 | 350 | 610 |
| | [mPa · s] | After storage for | 230 | 200 | 440 | 400 | 650 |
| | | 360 hours | | | | | |
| | | After storage for | 240 | 205 | 450 | 430 | 710 |
| | | 720 hours | | | | | |

| | | | | | |
|---|---|---|---|---|---|
| Storage stability | A | A | B | C | C |

1. A method for producing a maleimide resin by reacting a tetracarboxylic dianhydride (a1), an amine (a2), and a maleic anhydride (a3), the method comprising the steps of:
adding the amine (a2) to the tetracarboxylic dianhydride (a1) in the presence of an organic solvent to obtain a polyimide resin; and
adding the maleic anhydride (a3) to the polyimide resin to obtain the maleimide resin;
wherein the organic solvent includes at least one of γ-butyrolactone and N-ethyl-2-pyrrolidone, and
the amine (a2) includes a dimer diamine and a second amine other than the dimer diamine.

2. The method for producing a maleimide resin according to claim 1, wherein at least one of the tetracarboxylic dianhydride (a1) and the amine (a2) includes a compound having a fluorene skeleton.

3. The method for producing a maleimide resin according to claim 1, wherein the tetracarboxylic dianhydride (a1) includes at least one of 1,3,3a,4,5,9b-hexahydro-5-(tetrahydro-2,5-dioxo-3-furanyl) naphtho[1,2-c]furan-1,3-dione, 9,9-bis(3,4-dicarboxyphenyl) fluorene dianhydride, 9,9-bis[4-(3,4-dicarboxyphenoxy)phenyl]fluorene dianhydride, and 3,3′,4,4′-biphenyltetracarboxylic dianhydride.

4. The method for producing a maleimide resin according to claim 1, wherein the second amine contains at least one of norbornanediamine, 9,9-bis[4-(4-aminophenoxy)phenyl]fluorene, and 9,9-bis(4-aminophenyl) fluorene.

5. The method for producing a maleimide resin according to claim 1, wherein the dimer diamine contains at least one of a compound represented by the following General Formula (1) and a compound represented by the following General Formula (2): 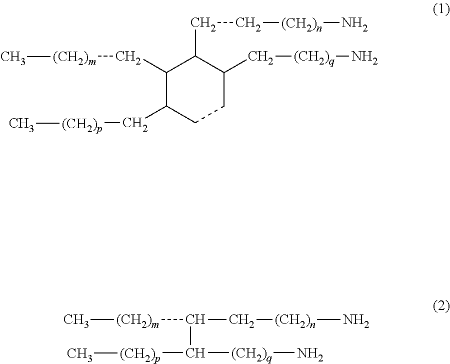
wherein, in Formulas (1) and (2), m, n, p, and q each represent an integer of 1 or more selected so as to satisfy m+n=6 to 17 and p+q=8 to 19, and a bond indicated by a broken line represents a carbon-carbon single bond or a carbon-carbon double bond, and
provided that when the bond indicated by the broken line is a carbon-carbon double bond, Formulas (1) and (2) have a structure in which the number of hydrogen atoms bonded to each carbon atom constituting the carbon-carbon double bond is subtracted by one from the numbers indicated in Formulas (1) and (2).

6. The method for producing a maleimide resin according to claim 1, wherein 0.30 to 1.00 mol of the tetracarboxylic dianhydride (a1) is reacted with 1.00 mol of the amine (a2).

7. The method for producing a maleimide resin according to claim 1, wherein the organic solvent further includes an aromatic hydrocarbon having a boiling point of 150° C. or higher.

8. The method for producing a maleimide resin according to claim 1, wherein the organic solvent further includes an alcohol having a boiling point of 100° C. or lower.

9. The method for producing a maleimide resin according to claim 1, wherein a content of the γ-butyrolactone and the N-ethyl-2-pyrrolidone in the organic solvent is 5 to 40 mass % based on a total amount of the organic solvent.
